(19) United States
(12) Patent Application Publication
(10) Pub. No.: US 2017/0022978 A1
(43) Pub. Date: Jan. 26, 2017

(54) SYSTEM FOR REDUCING MAINTENANCE FREQUENCY FOR BOLTS AND NUTS OF WIND TURBINE

(71) Applicant: Kevin Sheng-Yong Li, Irvine, CA (US)

(72) Inventor: Kevin Sheng-Yong Li, Irvine, CA (US)

(21) Appl. No.: 15/217,729

(22) Filed: Jul. 22, 2016

(30) Foreign Application Priority Data
Jul. 22, 2015 (CN) 201520536519.1

(51) Int. Cl. F03D 17/00; G01N 3/08

(52) U.S. Cl. CPC F03D 17/00; G01N 3/08

(57) ABSTRACT

A system for reducing maintenance frequency for bolts and nuts of a wind turbine comprises a plurality of fastening units, a PC data collector, a server and a terminal. The fastening unit has a bolt sequentially penetrates through a lower spacer, a sensor, an upper spacer, a wind turbine parts, a threaded ring, and a washer, and then a nut is engaged and tightly fastened on the bolt. With the fastening units, the system applied to the wind turbine is configured to create a double nut locking system thereby maintaining a preload tension force of the bolt in a safety operation range. Also, through the monitoring system including the sensor connected to the terminal through the PLC data collector and the server, a user can receive the real-time monitoring data of the preload tension force of the bolt to maintain and repair the wind turbine efficiently thereby preventing accidents.

### FIELD OF THE INVENTION

The present invention relates to a system for bolts and nuts of a wind turbine and more particularly to a system capable of reducing maintenance frequency for bolts and nuts of a wind turbine.

### BACKGROUND OF THE INVENTION

Generally, a wind turbine comprises a segmental tower, an engine room and a plurality of blades, and the components are usually connected and engaged with each other through a plurality bolts and nuts which is a manner convenient to engage or disengage parts of a large-scale mechanical equipment or apparatus. Currently, a kind of traditional nut which is tightened by fastening approach is applied to the connection between the components such as flanges, bearing rings and bearing seats of the wind turbine. However, since the surfaces between each two parts of the wind turbine, even at the same part but different positions, have different frictions, each of fastening degree of nuts needs to be precise to prevent loosening connection between the parts of the wind turbine. Also, the parts connected by traditional nuts cannot sustain for a long time and needs to be inspected and replaced frequently, which increases the risk of accidents and wastes the time and labors.

Moreover, although the nuts between the parts of the wind turbine are prone to loose, for now, there is no monitoring system for detecting loose nuts. Therefore, in order to maintain the safety of operation, the wind turbine is usually checked and repaired in every three, six or twelve months. In addition, the wind turbine needs to be shut down when maintenance which further reduces the power generation. Therefore, there remains a need for a new and improved design for a system for reducing maintenance frequency of a wind turbine to overcome the problems presented above.

### SUMMARY OF THE INVENTION

The present invention provides a system for reducing maintenance frequency of a wind turbine which comprises a plurality of fastening units, a PC data collector, a server and a terminal. The fastening unit has a bolt, an upper spacer and a lower spacer, a sensor, a wind turbine parts including flanges, bearing rings or other connecting parts, a threaded ring, a washer and a nut. The bolt has a bolt head and a threaded segment which are respectively formed at a lower end and an upper portion thereof. The sensor is disposed on the bolt together with the two spacers which are coupled on both sides of the sensor, and the bolt with the spacers and sensor penetrates though the wind turbine parts, the threaded ring and the washer sequentially, and engages with the nut to secure the components on the bolt. The upper spacer coupled between the sensor and a lower surface of the wind turbine parts is configured to prevent relative rotation occurred there between, and an upper surface of the washer is a processing plane and is coupled with a lower surface of the nut. Moreover, an inner periphery of the washer comprises an inner spline teeth which is configured to engage with an outer spline formed at an outer periphery of the threaded ring such that the threaded ring is configured to only upwardly or downwardly move along the inner spline teeth of the washer without relative rotation, and the washer is engaged with the wind turbine parts to prevent relative rotation occurred there between. Furthermore, the threaded ring is engaged with the threaded segment of the bolt such that after the nut is engaged and tightened on the bolt, the threaded ring is configured to only move upwardly instead of rotating relative to the bolt. Therefore, the nut which is tightened on the bolt is configured to work with the washer and the threaded ring to form a double nut locking system thereby maintaining a preload tension force of the bolt. Also, since the components are tightly coupled between the bolt head and the nut, the pressure acting on the sensor is equal to the preload tension force of the bolt. The pressure received by the sensor is configured to transmit through an inductive transmission wire to the PLC data collector to create datum which further are transmitted through a data transmission wire, the server and an internet wire to the terminal. Thus, a user can have real-time monitoring of the preload tension force of the bolt through the terminal.

Comparing with conventional system for a wind turbine, the present invention is advantageous because: (i) through the fastening units including the bolt, the nut and other components, the system applied to the wind turbine is configured to create the double nut locking system thereby maintaining the preload tension force of the bolt in a safety operation range; and (ii) through the monitoring system including the sensor connected to the terminal through the PLC data collector and the server, a user can receive the real-time monitoring data of the preload tension force of the bolt so as to maintain and repair the wind turbine efficiently thereby preventing accidents.

### BRIEF DESCRIPTION OF THE DRAWINGS

FIG. 1 is a three-dimensional view of a system for reducing maintenance frequency of wind turbine in the present invention.

FIG. 2 is another three-dimensional view of the system for reducing maintenance frequency of wind turbine in the present invention.

FIG. 3 is an exploded schematic view of the system for reducing maintenance frequency of wind turbine in the present invention.

FIG. 4 is a sectional view of the system for reducing maintenance frequency of wind turbine in the present invention.

FIG. 5 is an exploded schematic view of another embodiment of the system for reducing maintenance frequency of wind turbine in the present invention.

FIG. 6 is a sectional view of another embodiment of the system for reducing maintenance frequency of wind turbine in the present invention.

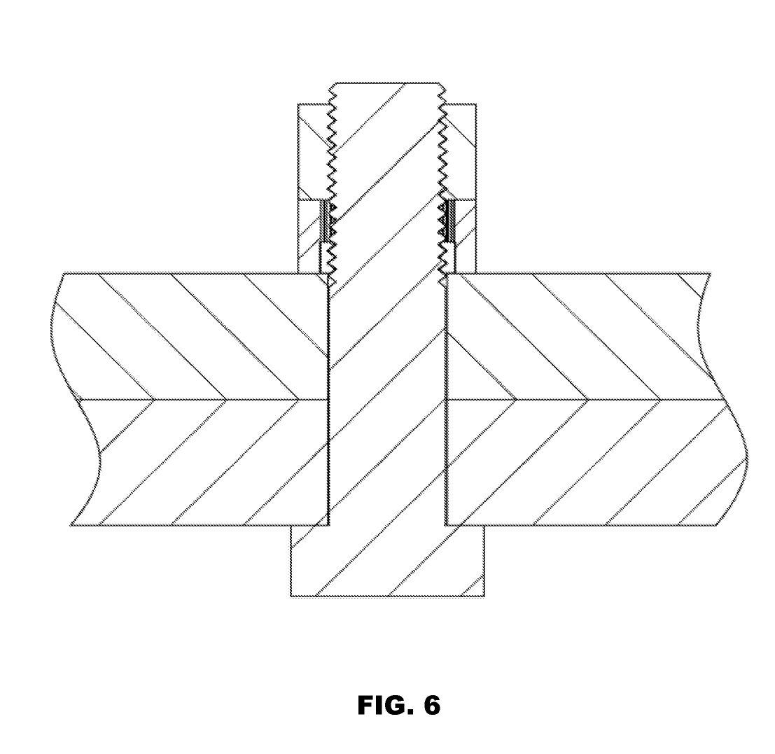

FIG. 7 is a sectional view of a washer of the system for reducing maintenance frequency of wind turbine in the present invention.

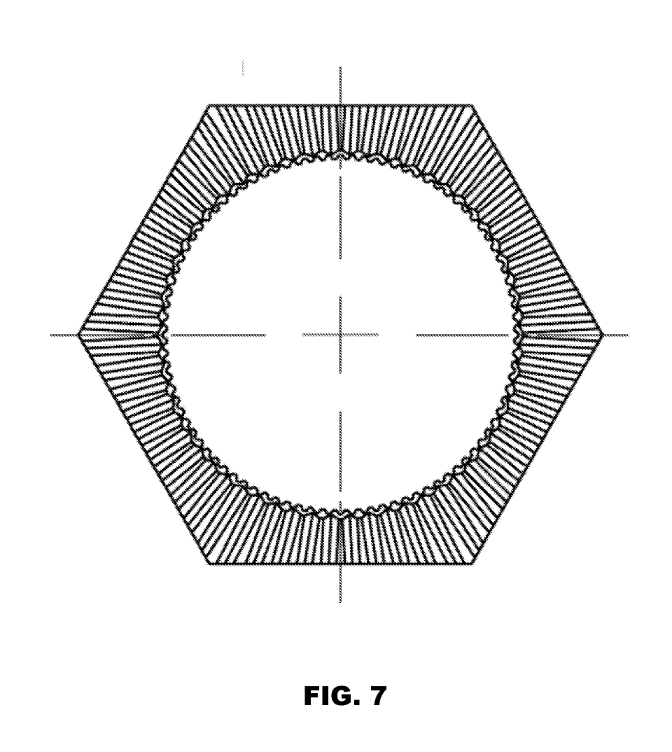

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

In order to further understand the goal, characteristics and effect of the present invention, a number of embodiments along with the drawings are illustrated as following:

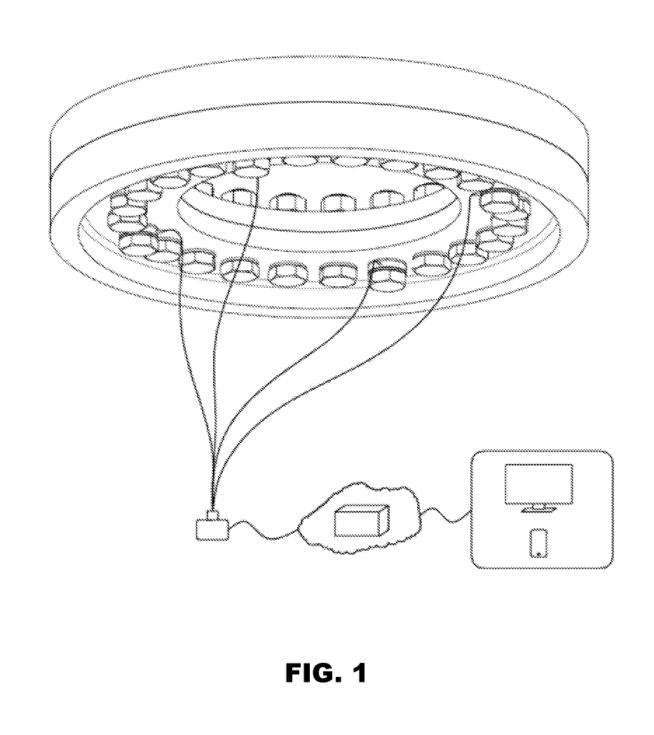

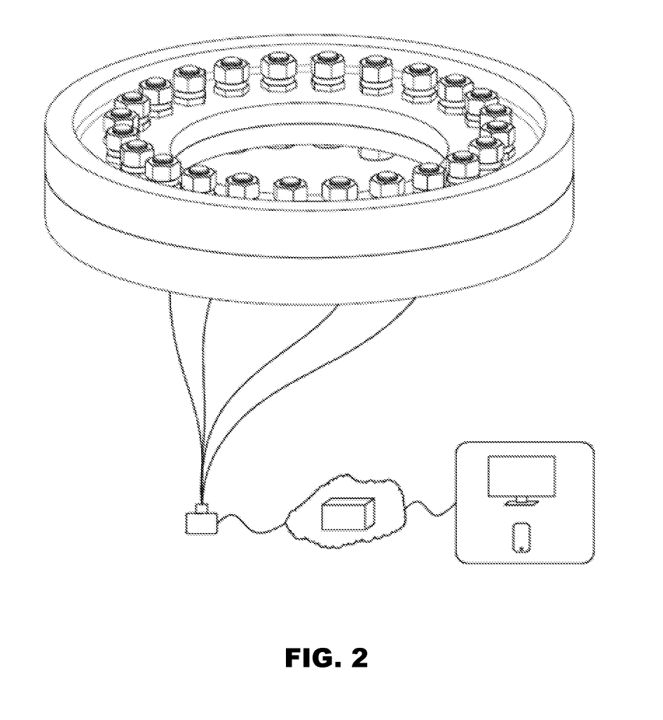

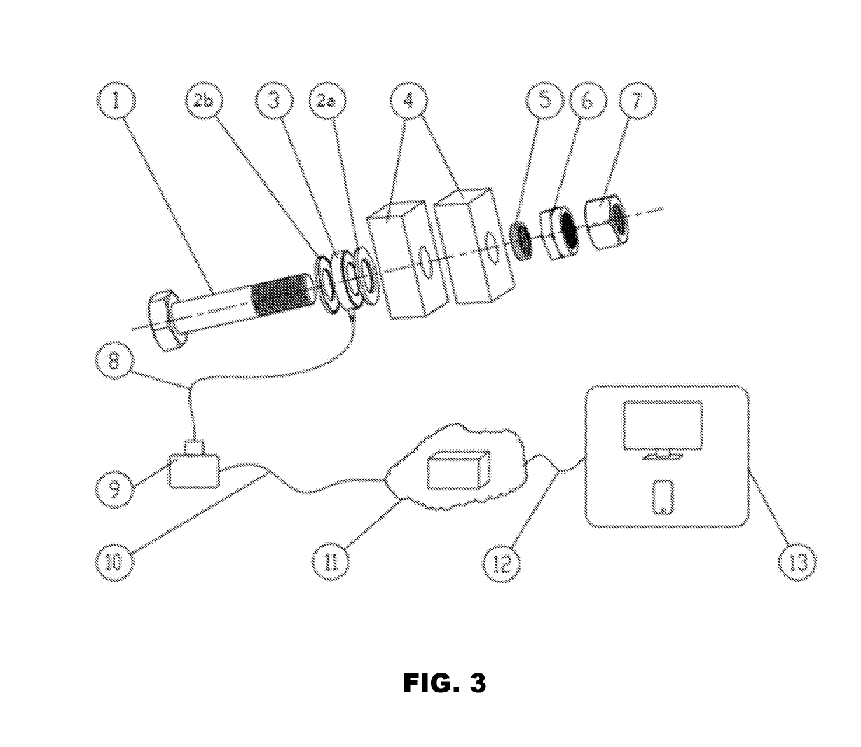

Referring to FIGS. 1 to 3, the present invention provides a system for reducing maintenance frequency of a wind turbine which comprises a plurality of fastening units, a PC data collector (9), a server (11) and a terminal (13). The fastening unit has a bolt (1), an upper spacer (2a) and a lower spacer (2b), a sensor (3), a wind turbine parts (4) including flanges, bearing rings or other connecting parts, a threaded ring (5), a washer (6) and a nut (7). The bolt (1) has a bolt head and a threaded segment which are respectively formed at a lower end and an upper portion thereof. The sensor (3) is disposed on the bolt (1) together with the two spacers (2a)(2b) which are coupled on both sides of the sensor(3), and the bolt (1) with the spacers (2a)(2b) and sensor (3) penetrates though the wind turbine parts (4), the threaded ring (5), the washer (6) sequentially, and engages with the nut (7) to secure the components on the bolt (1). The upper spacer (2a) coupled between the sensor (3) and a lower surface of the wind turbine parts (4) is configured to prevent relative rotation occurred there between, and an upper surface of the washer (6) is a processing plane and is coupled with a lower surface of the nut (7). Moreover, an inner periphery of the washer (6) comprises an inner spline teeth which is configured to engage with an outer spline formed at an outer periphery of the threaded ring (5) such that the threaded ring (5) is configured to only upwardly or downwardly move along the inner spline teeth of the washer (6) without relative rotation, and the washer (6) is engaged with the wind turbine parts (4) to prevent relative rotation occurred there between. Furthermore, the threaded ring (5) is engaged with the threaded segment of the bolt (1) such that after the nut (7) is engaged and tightened on the bolt (1), the threaded ring (5) is configured to only move upwardly instead of rotating relative to the bolt (1). Therefore, the nut (7) which is tightened on the bolt (1) is configured to work with the washer (6) and the threaded ring (5) to form a double nut locking system thereby maintaining a preload tension force of the bolt (1). Also, since the components are tightly coupled between the bolt head and the nut, the pressure acting on the sensor (3) is equal to the preload tension force of the bolt (1). The pressure received by the sensor (3) is configured to transmit through an inductive transmission wire (8) to the PLC data collector (9) to create datum which further are transmitted through a data transmission wire (10), the server (11) and an internet wire (12) to the terminal (13). Thus, a user can have real-time monitoring of the preload tension force of the bolt (1) through the terminal (13).

In one embodiment, the datum transmit from the sensor (3) to the PLC data collector (9) through a wireless communication method.

In another embodiment, the datum transmit from the PLC data collector (9) to the server (11) through the wireless communication method.

In still another embodiment, the datum transmit from the server (11) to the terminal (13) through the wireless communication method.

In a further embodiment, the server (11) is a computer or an online server such as Cloud server.

In still a further embodiment, the terminal (13) is a computer, a tablet or a smart phone.

In yet a further embodiment, the sensor (3) is configured to dispose on the bolt (1) without coupling with the spacers (2) on both sides thereof.

In a particular embodiment, the sensor is formed in a ring shape and is integrally formed on the bolt (1).

In a preferred embodiment, the bolt (1) has no the bolt head, and comprises two threaded segments at the upper portion and a lower portion thereof.

In still a preferred embodiment, the time span and timing of data transmission and storage of the PLC data collector (9) are configured to be settled according to needs.

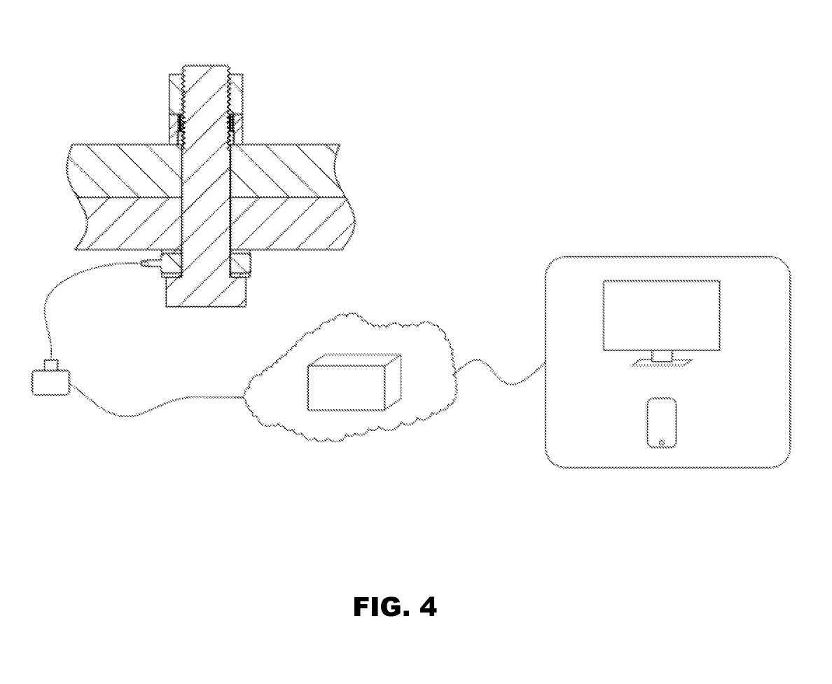

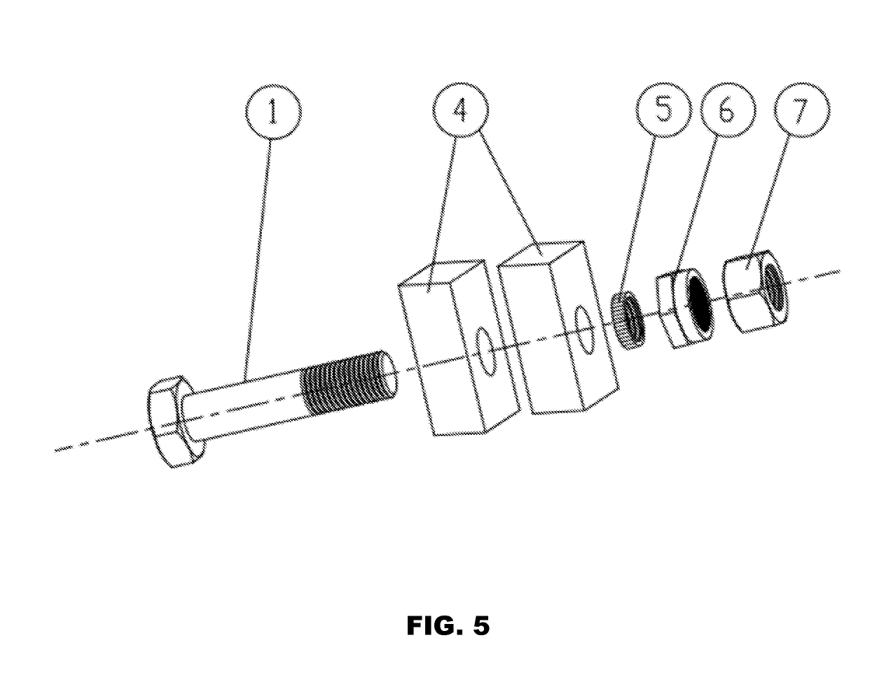

Referring to FIGS. 4 and 5, in another embodiment, the bolt (1) sequentially penetrates through the wind turbine parts (4) and threaded ring (5) and the washer (6), and the nut (7) is engaged and tightened on the bolt (1) through the threaded segment after the components are disposed on the bolt (1). A teeth surface formed at a lower surface of the washer (6) is configured to be engaged with an upper surface of the wind turbine parts (4). When the bolt (1) is pressed by the tightened nut (7), the washer (6) is engaged with the wind turbine parts (4) thus preventing relative rotation. The upper surface of the washer (6) is the processing plane and is coupled with lower surface of the nut (7). Moreover, the inner periphery of the washer (6) comprises the inner spline teeth which is configured to engage with the outer spline formed at the outer periphery of the threaded ring (5) such that the threaded ring (5) is configured to only upwardly or downwardly move along the inner spline teeth of the washer (6) without relative rotation, and the washer (6) is engaged with the wind turbine parts (4) to prevent relative rotation occurred there between. Furthermore, the threaded ring (5) is engaged with the threaded segment of the bolt (1) such that after the nut (7) is engaged and tightened on the bolt (1), the threaded ring (5) is configured to only move upwardly instead of rotating relative to the bolt (1). Therefore, the nut (7) which is tightened on the bolt (1) is configured to work with the washer (6) and the threaded ring (5) to form a double nut locking system thereby maintaining a preload tension force of the bolt (1) and achieving the safe operation of the wind turbine.

In an advantageous embodiment, the lower surface of the washer (6) is an engaging surface formed in a preferable shape which is configured to engage with the upper surface of the wind turbine parts (4).

In still an advantageous embodiment, the system in the present invention can also be applied to other machines or apparatus with bolts and nuts mechanism.

Comparing with conventional system for a wind turbine, the present invention is advantageous because:(i) through the fastening units including the bolt (1), the nut (7) and other components, the system applied to the wind turbine is configured to create the double nut locking system thereby maintaining the preload tension force of the bolt (1) in a safety operation range; and (ii) through the monitoring system including the sensor (3) connected to the terminal (13) through the PLC data collector (9) and the server (11), a user can receive the real-time monitoring data of the preload tension force of the bolt (1) so as to maintain and repair the wind turbine efficiently thereby preventing accidents.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A system for reducing maintenance frequency for bolts and nuts of wind turbine comprising:
a plurality of fastening units, and each of the fastening units having a bolt sequentially penetrating through a lower spacer, a sensor, an upper spacer, a wind turbine parts, a threaded ring and a washer, and then a nut engaged and tightly fastened on the bolt;
a PLC data collector electrically connected to the sensor through a inductive transmission wire and configured to convert measuring pressures from the sensor into machine-readable datum and to send the datum to a server through a data transmission wire;
the server which is electrically connected to the PLC data collector configured to receive datum from the PLC data collector and to send the datum to a terminal through an internet wire; and
the terminal electrically connected to the server and configured to receive datum from the server thereby allowing a user to receive real-time monitoring datum of the preload tension force of the bolt.

2. The system for reducing maintenance frequency for bolts and nuts of wind turbine of claim 1, where in a lower surface of the washer close to the wind turbine parts has a teeth surface which is configured to engage with an upper surface of the wind turbine parts.

3. The system for reducing maintenance frequency for bolts and nuts of wind turbine of claim 1, where in an inner periphery of the washer has an inner spline teeth which is configured to engage with an outer spline formed at an outer periphery of the threaded ring.

4. The system for reducing maintenance frequency for bolts and nuts of wind turbine of claim 1, where in the wind turbine parts includes flanges, bearing rings and bearing seats.

5. The system for reducing maintenance frequency for bolts and nuts of wind turbine of claim 1, where in the sensor is formed in a ring shape and is integrally formed on the bolt.

6. The system for reducing maintenance frequency for bolts and nuts of wind turbine of claim 1, wherein a bolt head and a threaded segment are respectively formed at a lower end and an upper portion of the bolt.

7. The system for reducing maintenance frequency for bolts and nuts of wind turbine of claim 1, wherein two threaded segments are respectively formed at a lower portion and the upper portion of the bolt, and the nut is engaged with either threaded segment.

8. The system for reducing maintenance frequency for bolts and nuts of wind turbine of claim 1, where in the time span and timing of data transmission and data storage of the PLC data collector are configured to be settled according to needs.

9. The system for reducing maintenance frequency for bolts and nuts of wind turbine of claim 1, wherein the datum transmit from the sensor to the PLC data collector, from the PLC data collector to the server, or from the server to the terminal through a wireless communication method.

10. The system for reducing maintenance frequency for bolts and nuts of wind turbine of claim 1, where in both sides of the sensor are respectively and directly coupled with a lower end of the bolt and the wind turbine parts without the spacers.
